(19) United States
(12) Patent Application Publication
(10) Pub. No.: US 2002/0066190 A1
(43) Pub. Date: Jun. 6, 2002

(54) Guide means for a circular saw

(76) Inventors: Michael Fey, Kaufering (DE); Michael Neumeier, Steingaden (DE)

Correspondence Address: DAVID TOREN, ESQ., SIDLEY, AUSTIN, BROWN & WOOD, LLP, 875 THIRD AVE, NEW YORK, NY, 10022, US

(21) Appl. No.: 09/935,976

(22) Filed: Aug. 23, 2001

(30) Foreign Application Priority Data
Aug. 28, 2000 (DE) 100 42179.2

(51) Int. Cl. B23D 47/02

(52) U.S. Cl. 30/371

(57) ABSTRACT

A hand-held power tool has a drive unit for a tool (5) and a baseplate (2) to guide the drive unit over a surface (3) of a workpiece (4). To ensure the smoothest and straightest possible guidance of the drive unit in a working direction (A), the baseplate (2), on its ends regions (11) facing the working direction, has a one-piece guide roller (12) with an anti-slip coating.

### BACKGROUND OF THE INVENTION

The invention relates to a hand-held power tool, such as a circular saw or the like, comprising a baseplate that serves as a guide having at least one of the two end regions facing the working direction mounting a guide roller that can be brought into contact with a workpiece to be processed.

Hand-held power tools of the type described above have a guide with a baseplate in order to guide a drive unit with a tool, for example, a circular saw blade, over a surface of a workpiece to be processed. Guide rollers mounted on at least one of the two end regions of the baseplate make it easy to advance the drive unit on the workpiece by reducing the friction.

European Patent No. 340,467 A2 describes such a hand-held power tool having two guide rollers mounted on the end regions facing the work.

An advantage of the known solution is that the drive unit can be moved over the surface of the workpiece without much resistance caused by friction. Moreover, this also greatly reduces the likelihood of the baseplate getting caught on the workpiece.

A drawback of the known hand-held power tool is that the guide rollers also make it more difficult to guide the power tool in a straight line in a working direction on the surface of the workpiece. In order to avoid such an undesired deviation, an additional guide, for example, a parallel stop, has to be used.

### SUMMARY OF THE INVENTION

The present invention is based on the objective of providing a hand-held power tool that can be easily moved in the advancing or working direction and that also guides the power tool in the working direction in order to make a straight-line cut. Moreover, the hand-held power tool is cost-effective to manufacture and simple to handle.

According to the invention, this objective is achieved in that the guide roller has contact regions for the workpiece that generate equal circumferential speeds and that are rigidly coupled to each other at a distance measured perpendicular to the working direction.

Since the contact regions are rigidly coupled to each other and have an equal circumferential speed with respect to the workpiece, it is ensured that the power tool can be moved in a straight line in the working direction of the drive unit. All of the points of the baseplate in the contact regions move at the same speed in the working direction.

Advantageously, the contact regions extend over the entire length of the guide roller in order to ensure cost-effective production, since a coupling can then be dispensed with. Moreover, as a result, a contact region with a maximum extent is achieved, which translates into a high stability of the guidance. This embodiment is particularly advantageous with workpieces that have very smooth surfaces. Furthermore, the enlarged contact region brings about a better distribution of the forces exerted on the surface by the guide rollers.

Preferably, the contact regions are situated on the two ends of the guide roller in order to achieve the best possible guidance on uneven surfaces.

In order to achieve a straight-line movement, even if the advancing force is unevenly distributed, in a preferred embodiment, the contact regions extend on both sides of the kerf. The kerf is formed by the cut made by the tool into the surface of the workpiece to be processed. As a result, the baseplate with the drive unit moves at the same speed on both sides of the kerf, which ensures a straight-line movement in the working direction.

The guide rollers are advantageously detachably connected to the baseplate in order to allow them to be disassembled. Such a disassembly can be necessary, for example, if it is desired to make a cut that is not straight. Furthermore, the guide rollers can then also be disassembled for transportation. For example, the attachment means can be used for the parallel stop.

Preferably, the contact regions have an anti-slip coating in order to avoid uncontrolled sliding on a smooth surface.

An especially optimized, preferred embodiment is one in which the anti-slip coating is made of rubber.

The end regions of the baseplate facing the working direction are preferably provided with a guide roller in order to be able to advance with the least possible friction loss. As a result, the hand-held power tool is especially easy to handle.

The guide roller can advantageously be fastened to the attachment means of the baseplate by a guide means. The guide means is advantageously cylindrical in shape in the region of the attachment means so that the distance between the baseplate and the surface of the workpiece can be adjusted.

### BRIEF DESCRIPTION OF DRAWINGS

The invention will be explained below with reference to an embodiment. The following is shown:

FIG. 1—is a side view of a hand-held power tool embodying the invention; and

FIG. 2—is a plan view of the hand-held power tool embodying the invention.

### BRIEF DESCRIPTION OF THE INVENTION

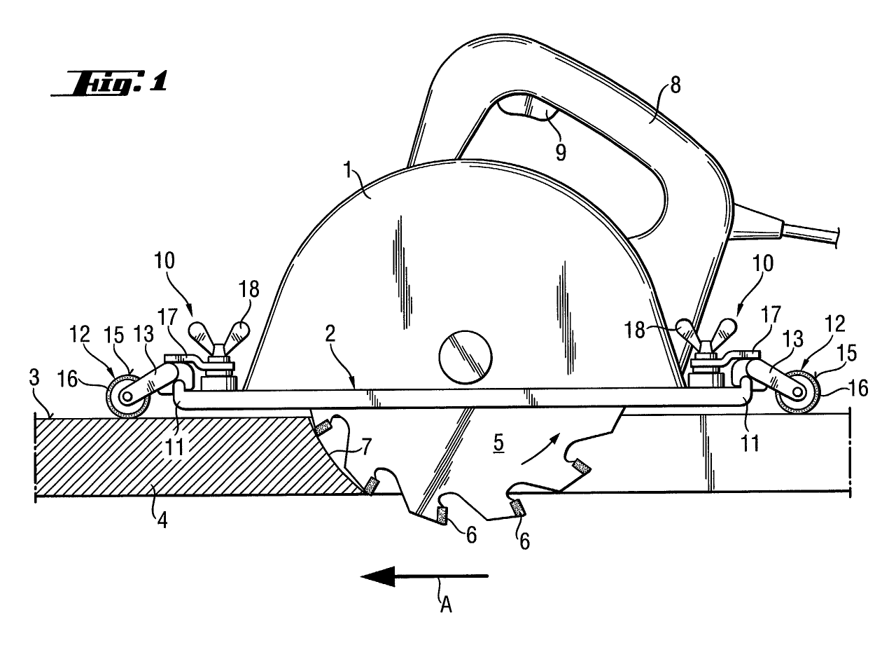

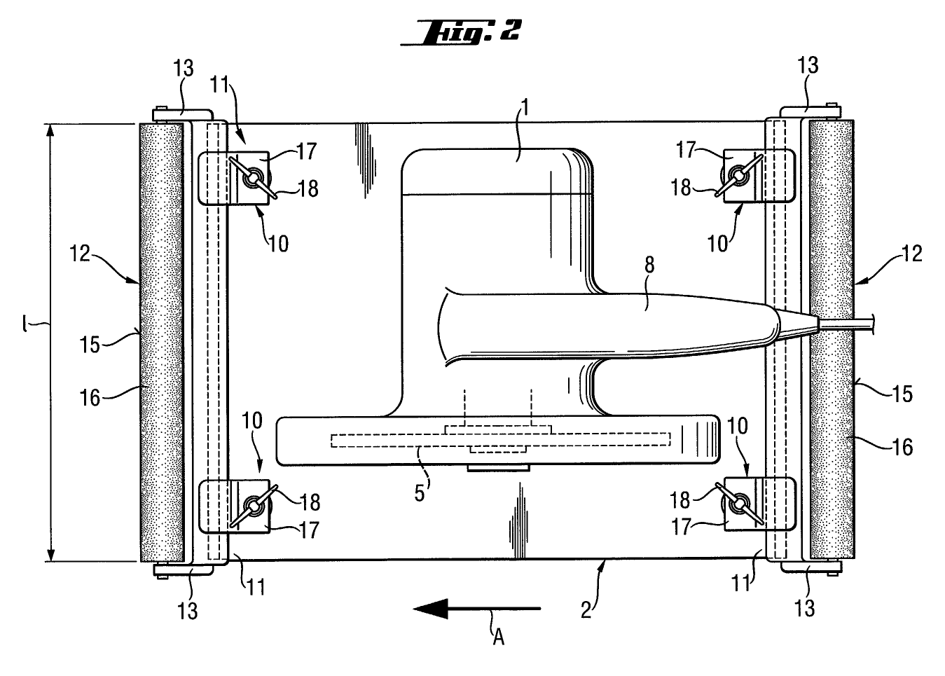

FIGS. 1 and 2 show a hand-held power tool embodying the invention, such as a circular saw, comprising a drive unit that is mounted in a housing 1 and guided by a baseplate 2 over a surface 3 of a workpiece 4.

The drive unit has a tool 5, a circular saw blade, that is driven by a motor (not shown here). Along the outer circumference of the tool 5, there are several hard metal members 6 that are, for example, welded on. The tool 5 enters the workpiece 4 in a kerf 7.

The housing 1 has a handle 8 with which the user exerts force so that the hand-held power tool moves in the working direction A under the effect of force. At the same time, the handle 8 also serves as a positioning aid for the user to position the hand-held power tool on the surface 3. A switch element 9 arranged in the handle 8 serves to switch the motor ON and OFF.

The baseplate 2 has a guide roller 12 at each of the two end regions 11 facing the working direction and, on the side facing away from the workpiece, it has an attachment means 10 for a parallel stop (not shown here). The guide rollers 12 are each pivoted on a guide means 13 that is detachably connected to the baseplate 2 by the attachment means 10.

The surface region 15 of the one-piece, cylindrical guide roller 12 is in contact with the surface 3 of the workpiece 4, thereby forming a contact region. The contact region extends over the entire length l of the guide roller 12. The surface region 15 has an anti-slip coating 16 made of an elastic material, such as rubber. This avoids an uncontrolled sliding of the hand-held power tool on the surface 3. The guide roller 12 extends crosswise to the working direction A over the entire width of the baseplate 2.

The attachment means 10 has a clamping tab 17 that is detachably secured to the baseplate 2 by means of a screw 18. In the clamped position, as shown in FIGS. 1 and 2, the screw 18 presses the guide means 13 onto the side of the baseplate 2 facing away from the workpiece. By loosening the screw, the clamping tab 17 can be swiveled away from the guide means 13, and the guide means 13, together with the guide roller 12, can be removed from the hand-held power tool.

What is claimed is:

1. A hand-held power tool, such as a circular saw and a similar tool, comprising a planar baseplate (2), having a first surface facing a workpiece (4) and a second surface facing away from the workpiece (4) and a first end region leading in a working direction (A), of said tool and a second end region trailing in the working direction (A), a guide roller (12) mounted on said baseplate and arranged to contact the workpiece (4) wherein said guide roller (12) has contact regions thereon for contacting the workpiece (4) with the contact regions generating equal circumferential speeds and rigidly coupled to one another at a distance extending perpendicularly to the working direction (A).

2. A hand-held power tool, as set forth in claim 1, wherein said contact regions extend for a full length (l) of said guide roller (12).

3. A hand-held power tool, as set forth in claim 1, wherein said contact regions are located at a first and a second end region of said guide roller (12) and are spaced apart along the length (l) of the guide roller.

4. A hand-held power tool, as set forth in claim 3, wherein said power tool cuts a kerf extending in the working direction in said workpiece and said contact regions thereof extend laterally on both sides of said kerf (7).

5. A hand-held power tool, as set forth in claim 4, wherein said guide roller (12) is detachably connected to the baseplate (2).

6. A hand-held power tool, as set forth in claim 1, wherein said contact regions have an anti-slip coating (16).

7. A hand-held power tool, as set forth in claim 6, wherein said anti-slip coating (16) is made of rubber.

8. A hand-held power tool, as set forth in claim 1, wherein the first and second end regions (11) of said baseplate mount one said guide roller (12).
